(19) United States
(12) Patent Application Publication
(10) Pub. No.: US 2004/0260670 A1
(43) Pub. Date: Dec. 23, 2004

(54) Network file server, information processing apparatus, program and information recording medium

(75) Inventors: Junzo Tokimitsu, Kawasaki (JP); Kazuhiko Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/777,678

(22) Filed: Feb. 13, 2004

(30) Foreign Application Priority Data
Jun. 23, 2003 (JP) 2003-177656

(51) Int. Cl. G06F 7/00

(52) U.S. Cl. 707/1

(57) ABSTRACT

A network file server includes: a data storage device; a request processing part connected to each server on a user's side via a predetermined backbone communication network, receiving a request from the server on the user's side for data processing including access to the data storage device, and issuing an instruction to a storage device management part for analyzing and responding to the request; and the data storage device management part connected with the request processing part via a predetermined local communication network, and executing predetermined processing including access to the data storage device based on the instruction issued by the request processing part.

### BACKGROUND OF THE INVENTION

1. Field of the Invention

The present invention relates to a network file server, an information processing apparatus and a computer readable program, and, in particular, to a network file server rich in scalability and having a capability of flexibly responding to a request for improving the processing capability, an information processing apparatus included in the network file server, and a computer readable program for causing a computer to execute the operation of the information processing apparatus.

2. Description of the Related Art

A so-called network file server which is connected with a backbone communication network, and has a capability of sharing data among many servers on a user's side which are also connected with the backbone communication network is advantageous since it provides a system to achieve effective utilization of information processing resources, and also, to enable respective users who utilize it to share common information in a specific organization so as to improve the work efficiency easily.

Such a network file server (generally, referred to as a NAS (Network Attached Storage) server) makes information stored in a storage (disk) connected to the own apparatus or built therein accessible for clients (business servers or so) via a communication network such as a LAN or so.

FIG. 1 shows a configuration of a network file server in a so-called ‘disk-built-in type’, where the network file server 200 has disk apparatuses 210-1 through 210-m built therein as storages therefor. On the other hand, FIG. 2 shows another network file server in a so-called ‘disk-connected type’, where, to the network file server 300, disk apparatuses 410-1 through 410-m are connected externally as separate storages therefor.

It is assumed that, to a network file server having such a configuration, for the purpose of business extension, load sharing for the network file server itself or so, a new network file server is added. In such a case, the following problems may occur for each of the types of the network file servers described above with reference to FIGS. 1 and 2.

That is, in the network file server in the disk-built-in type shown in FIG. 1, as shown in FIG. 3, the above-mentioned system extension can be achieved only by connecting a new network file server 200-2 to a network (LAN or so) 20 originally used for connecting between the clients (for example, personal computers) 10-1 through 10-n and the existing network file server 200-1.

However, in this case, disks which are made accessible for the clients are the storages built in and thus belonging to the network file servers 200-1 and 200-2, respectively, and thus, it may be difficult that the information stored in these storages are shared among the respective clients in a uniform way. That is, it is assumed for example that a special communication protocol is required for the first client 10-1 to access the disk apparatuses 210-1, . . . , built in the network file server 200-1 via the network file server 200-1, while another special communication protocol is required for the second client 10-n to access the disk apparatuses 210-20, . . . , built in the currently added new network file server 200-2 via the network file server 200-2. In such a case, for each client, it may be necessary to previously perform a predetermined setting work for making the relevant special communication protocol usable by the client for the purpose of accessing data stored in the disk built in the other sever.

On the other hand, in case of the disk-connected type as shown in FIG. 2, as shown in FIG. 4, in parallel to the existing server 300-1, a new server 300-2 is connected to a network 20, and also, the same is connected to existing disks (storages) 400. By providing such a configuration, all the existing disks 400-1 through 400-m can be shared among these two servers 300-1 and 300-2. Thus, the storages can be shared among all the clients.

However, in order to build up the configuration shown in FIG. 4, different from the case of FIG. 3 in which it is necessary to merely connect the new network file server to the backbone network, it is necessary to execute a storage connection work which in general requires a somewhat high-order and special engineering skill. Such a type of storage connection work generally includes \mathring{1} an operation of defining the disks which are made accessible for the new network file server 300-2 at the end of the storage (disk apparatus 400); \mathring{2} an operation of defining the disks to be connected in the system at the end of the new network file server 300-2; and \mathring{3} an operation of confirming at the end of the new network file server 300-2 that the disks are positively recognized thereby.

Furthermore, in this case, as shown in FIG. 5, in order to connect the network file server to the storage (or via a switch), it is necessary to install an HBA (host bus adapter: FC card/SCSI (Small Computer System Interface) card) at the end of the network file server. On the other hand, similarly, at the end of the storage, a physical device such as a port (CA: channel adapter) is required for connecting with the HBA (or via the switch).

Furthermore, as shown in FIG. 4, in case where the plurality of network file servers are connected with the storage in common, it is necessary to establish matching in caches between the respective servers, provision of which cashes is advantageous for improving the access efficiency. For achieving the matching in the cache between the respective servers, cache control required therefor may become complicated.

### SUMMARY OF THE INVENTION

The present invention has been devised for the purpose of solving these problems, and an object of the present invention is to provide a scalable network file server, not requiring relatively high-order and special engineering skill for storage connection work, enabling stored data sharable between clients (business servers or so), and also, enabling easy improvement in the information processing capability for data writing/reading in response to an increase in demand.

According to the present invention, a request processing part connected to each server on a user's side via a predetermined backbone communication network, receiving a request from the server on the user's side for data processing including access to a data storage device, and issuing an instruction to a storage device management part for analyzing and responding to the request; and the data storage device management part connected with the request processing part via a predetermined local communication network, and executing predetermined processing including access to the data storage device based on the instruction issued by the request processing part are provided.

In this configuration, as the storage device management part manages the entirety of the data storage device, it is possible to achieve improvement in the information processing capability only by connecting a new request processing part to the existing local communication network (such as a LAN) for the purpose of extension. Furthermore, in this case, as the storage device management part manages the entirety of the data storage device as mentioned above, each server on the user's side can sharably treat data stored in the data storage device via the request processing parts including the thus newly added one and the storage device management part. Thus, in this configuration, a necessary operation to be performed for the extension work is only to connect the new request processing part to the local communication network such as a LAN, as in the example shown in FIG. 3. Accordingly, it is possible to establish the storage system sharable among the users without performing a storage connection work generally requiring a high-order special engineering skill.

Furthermore, as mentioned above, the necessary operation is only to connect a new request processing part to the local communication network such as a LAN, it is not necessary to directly connect it to the data storage device or via a switch. Thereby, in the connection required therefor, a physical device such as an HBA, CA or so shown in FIG. 5 is not needed. In the configuration according to the present invention, a predetermined card (NIC: network interface card or so) is needed for connecting the new request processing part to the local communication network. However, such a type of devices is merely ones which a common server inherently has in many cases, and thus, provision of such a type of devices does not amount to provision of extra devices in many cases.

Furthermore, in the configuration according to the present invention, all caches are managed by the storage device management part collectively. Thereby, a complicated cache control otherwise required for particularly providing matching therefor is not needed. Further, even in a case where each request processing part has a cache individually, these caches are used after a predetermined transaction needed for each processing is established. As a result, a complicated control for providing matching should not be particularly needed.

Thus, according to the present invention, a functional separation is made between the request processing part which accepts a request from a server on the user's side and analyses it, and the storage device management part which manages the data storage device and executes actual access thereto. And also, the request processing part and the storage device management part are connected together via a communication network. As a result, a necessary operation to increase the processing capability therein is only to add a new request processing part, and also, in this case, specifically, a necessary work is only to connect the new request processing part to the communication network. Thus, it is possible to improve the system performance easily and to improve the scalability in the system.

Furthermore, as the connection between the request processing part and the storage device management part is made by the communication network, it is possible to easily increase the access speed therebetween only by increasing the communication band in the network.

Furthermore, in order to increase the data storage capacity, it is necessary only to add a new data storage device, and also, in this case, a necessary work is only to connect the new data storage device to the storage device management part. Accordingly, there is no need to change the existing setting or so in the request processing parts.

Thus, according to the present invention, it is possible to build a storage system rich in scalability which can flexibly respond to increase/decrease in demand.

### BRIEF DESCRIPTION OF DRAWINGS

Other objects and further features of the present invention will become more apparent from the following detailed description when read in conjunction with the accompanying drawings:

FIG. 1 shows a configuration of a network file server in a disk-built-in type in one example of the related art;

FIG. 2 shows a configuration of a network file server in a disk-connected type in another example of the related art;

FIG. 3 illustrates a possible problem in a case where extension is performed for the above-mentioned network file server in the disk-built-in type;

FIGS. 4 and 5 illustrate possible problems in a case where extension is performed for the above-mentioned network file server in the disk-connected type;

FIG. 6 shows a block diagram of a network storage system including a network file server in an embodiment of the present invention;

FIG. 7 shows a further detailed block diagram of the network file server in the embodiment of the present invention shown in FIG. 6;

FIG. 8 shows a block diagram illustrating an internal configuration of a request processing server shown in FIGS. 6 and 7;

FIG. 9 shows a block diagram illustrating an internal configuration of a volume management server shown in FIGS. 6 and 7;

FIG. 10 shows an operation flow chart illustrating a flow of processing performed by the request processing server shown in FIG. 8; and

FIG. 11 shows an operation flow chart illustrating a flow of processing performed by the volume management server shown in FIG. 9.

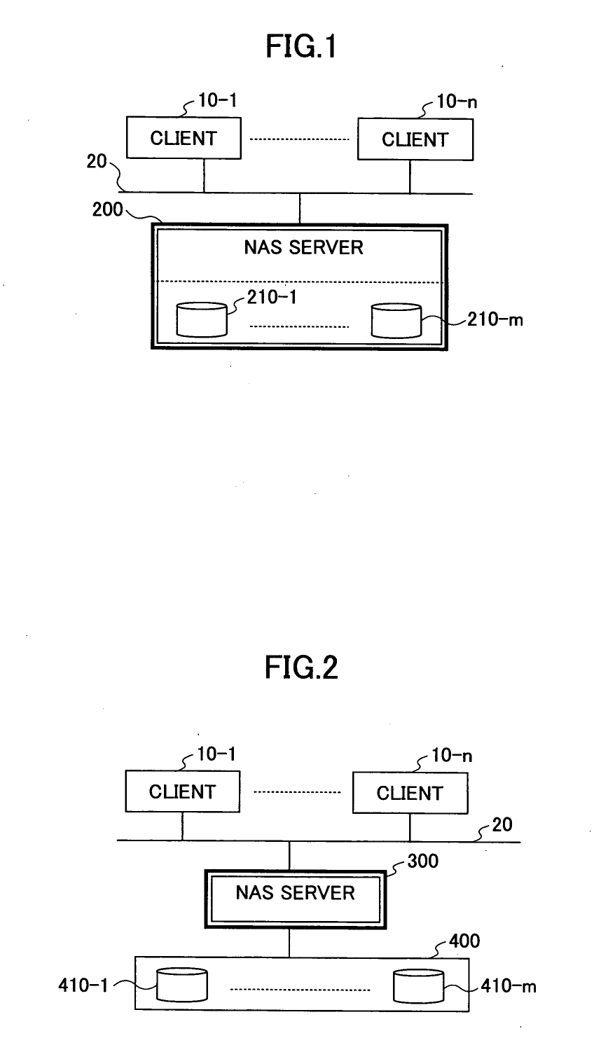

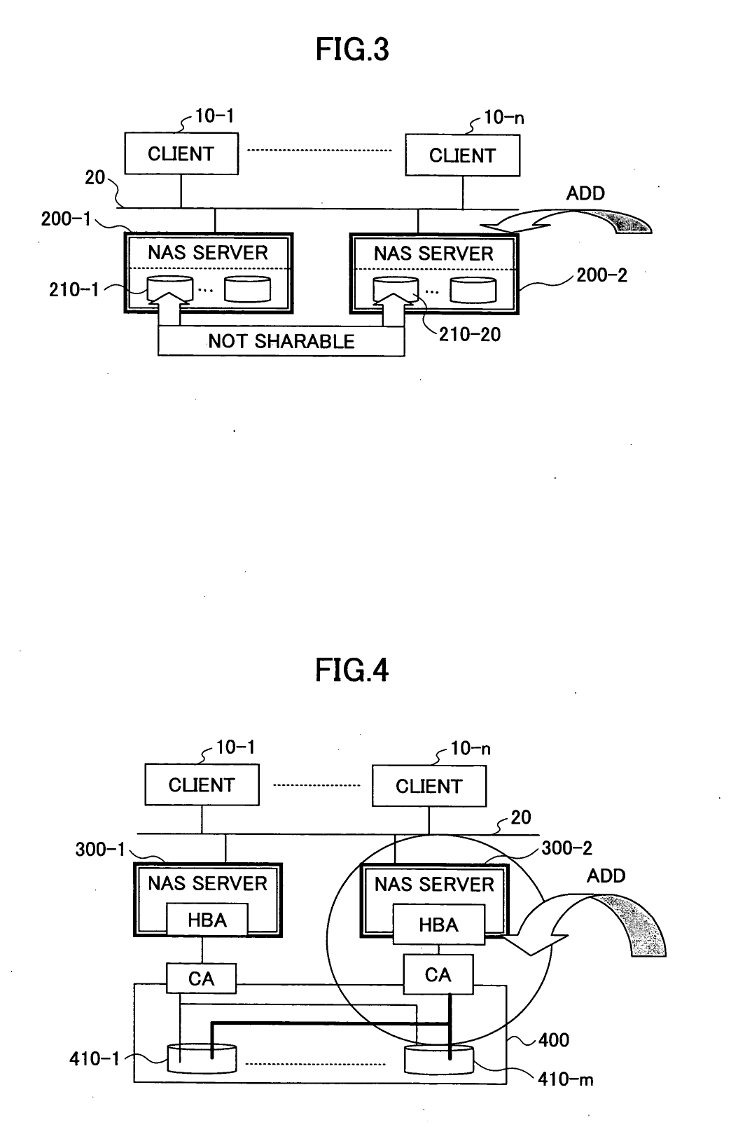

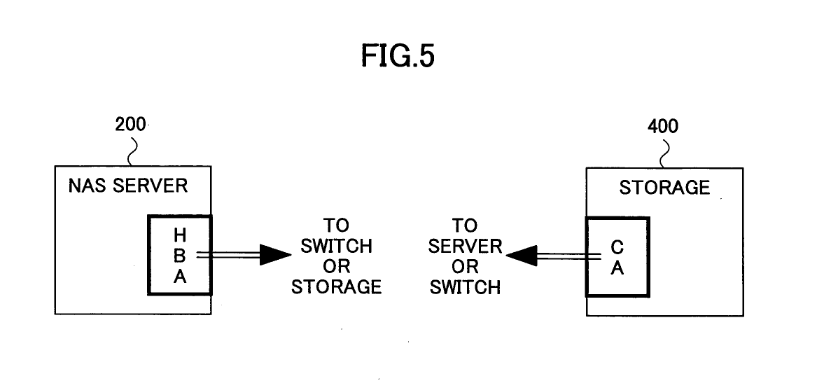

### DETAILED DESCRIPTION OF THE PREFERRED EMBODIMENT

An embodiment of the present invention will now be described with reference to drawings.

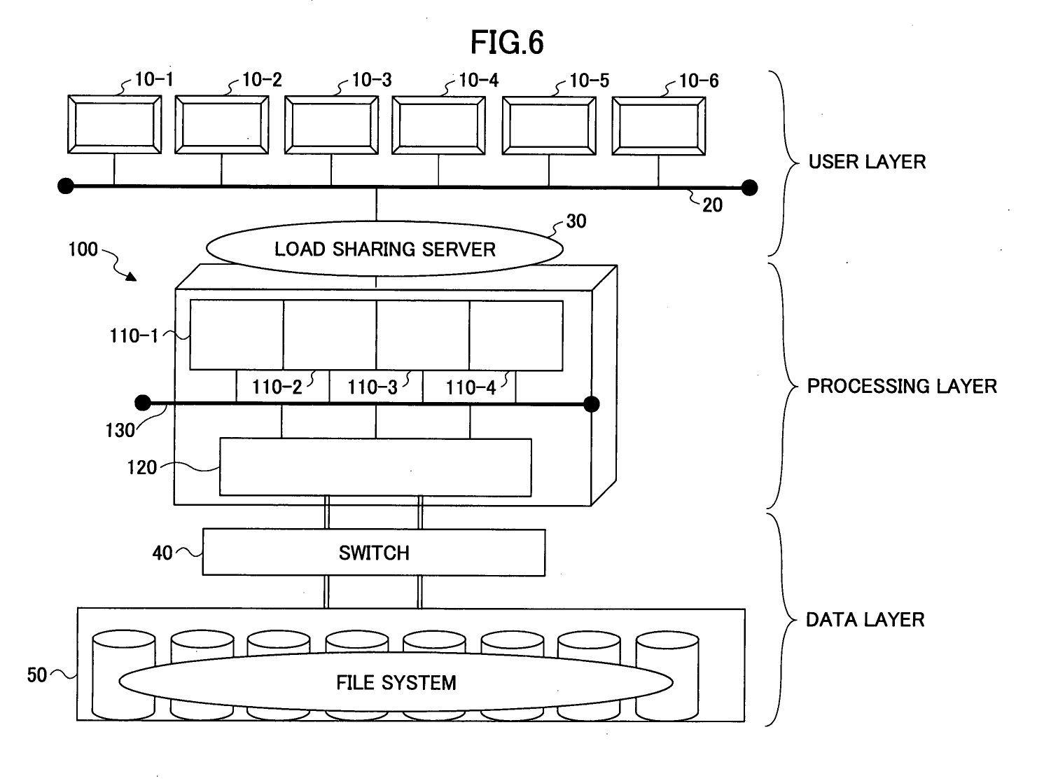

FIG. 6 shows a block diagram of the entire configuration of a network storage system including a network file server 100 in the embodiment of the present invention. The network storage system shown includes a user layer including business servers 10-1 through 10-6 acting as clients, a processing layer processing data stored in a data layer according to a processing request given by the user layer, and the data layer.

According to the embodiment of the present invention, a system is provided, for which extension in the data processing capacity or processing capability in the network file server 100 included in the processing layer can be achieved without affecting the above-mentioned user layer and the data layer, i.e., without needing a special work such as setting alteration work or so in each apparatus included in the user layer and the data layer. The above-mentioned increase in the data processing capacity or processing capability is achieved specifically by increasing the number of the request processing servers 110-1 through 110-4, i.e., by adding a new request processing server 110-5 to the system, for example.

A load sharing server 30 has a function of appropriately distributing access requests for data stored in a storage 50 issued by respective business servers 10-1 through 10-6 included in the user layer among respective request processing servers 110-1 through 110-4 included in the processing layer. A switch 40 has a function of appropriately repeating data between a volume management server 120 in the network file server 1 and the storage 50 in the data layer.

The business servers 10-1 through 10-6 are server computers respectively, each of which has a predetermined application program of a relevant user installed therein and operates therewith. Each user utilizes data stored in the storage 50 in the data layer of the network storage system, executes the relevant application program therewith so as to achieve his/her intended object.

These business servers 10-1 through 10-6 (which may be collectively referred to as business servers 10 or any one of which may be typically referred to as a business server 10, hereinafter) and the load sharing server 30 are mutually connected by a backbone LAN (Local Area Network) 20. The network file server 100 in the embodiment of the present invention is thus connected with the backbone LAN 20 via the load sharing server 30, and then, is connected with the respective business servers 10 therethrough, as shown. Further, the network file server 100 includes the plurality of request processing servers 110-1 through 110-4 (which may be collectively referred to as request processing servers 110 or any one of which may be typically referred to as a request processing server 110, hereinafter) and the volume management server 120 as shown.

These request processing servers 110 analyze access requests given by the respective business servers 10, and respond to the requests. The volume management server 120 manages the entirety of the storage 50, and executes an operation of accessing respective disk apparatuses included in the storage 50. Further, data transfer between the request processing servers 110 and the volume management server 120 is performed via a local LAN (Local Area Network) 130.

The storage 50 includes the plurality of disk apparatuses (which may be simply and generally referred to as disks 50 or any one of which may be simply and typically referred to as a disk 50 hereinafter), and therewith forms a file storage area (file system) sharable among all the business servers 10.

This network file system 100 provides the following function: That is, the network file system 100 makes the above-mentioned file system made of the storage 50 accessible for the business servers 10 via the communication network. This function is basically same as that of a well-known NFS (network file system) server.

The network file server 100 in the embodiment of the present invention is different from a conventional NFS server by the following points: That is, the network file server 100 has a configuration of separately including two functional parts, i.e., the request processing servers 100 which accept access requests from the business servers 10, analyze a network access protocol thereof and respond to the requests; and the volume management server 120 managing the storage (disks) 50, and performing actual access to the disks 50 for reading data therefrom and writing data therein. By applying such a configuration, the following advantages are provided:

That is, by providing the volume management server 120 which collectively manages the entire storage 50, it is possible to build the file system sharable by all the clients (business servers 10). Furthermore, the volume management server 120 provides a storage management function for the storage 50, and also, the request processing servers 110 are connected with the volume management server 120 via the communication network 130 as shown in FIG. 6. Accordingly, upon an occurrence of a request for extension of the request processing servers 110, a storage connection work requiring a particularly special engineering skill such as that described above with reference to FIG. 4 is not needed. In other words, it is possible to achieve the above-mentioned extension only with a relatively easy standard network connection work. Thus, the scalability in the system can be effectively improved.

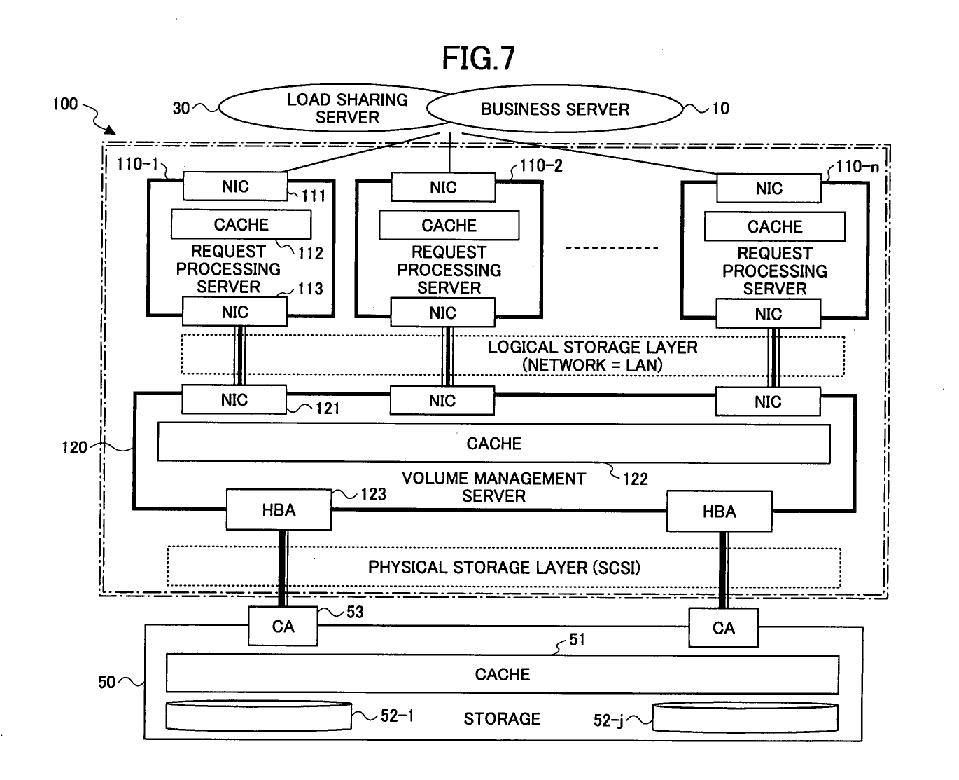

With reference to figures, the configuration of the network file server 100 in the embodiment of the present invention will now be described in detail. As shown in FIG. 7, the network file server 100 includes one or a plurality of request processing servers 110 and one or a plurality of volume management server 120. There among, the volume management server 120 is connected to the storage (disks) 50, the contents of which are made accessible for all the business servers 10, and manages all the information stored in the storage 50.

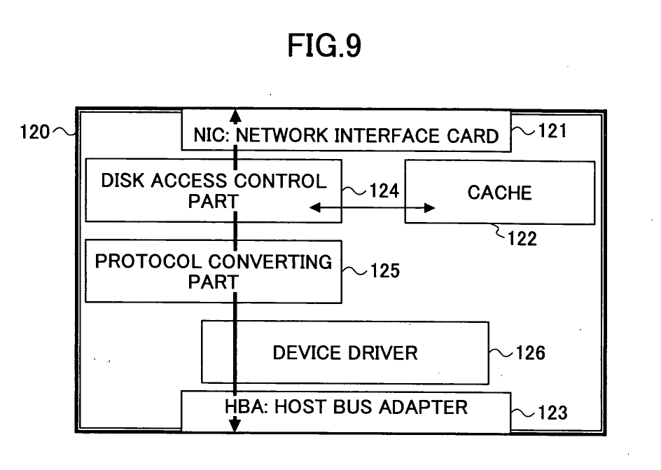

As shown in FIG. 9, the volume management server 120 includes an HBA (SCSI card or FC card) 123 and a device (NIC: LAN card) 121 used for connecting with the communication network. Further, the volume management server 120 has a function of making the disks in the storage 50 which the network file server 100 manages accessible for the request processing servers 110 not physically but logically (virtually).

The volume management server 120 further has a function of accessing the disks 50 with a disk access protocol (SCSI protocol or fibre channel protocol). Thus, the volume management server 120 has a function of converting a disk access request from the request processing server 110 into the above-mentioned disk access protocol (SCSI or fibre channel protocol). Furthermore, the volume management server 120 has a cache 122, and, when data thus requested by the request processing server 110 occurs in the cache 122, the volume management server 120 does not actually access the disks 50 but reads the data from the cache 122 and transfers it to the request processing server 110 as a response.

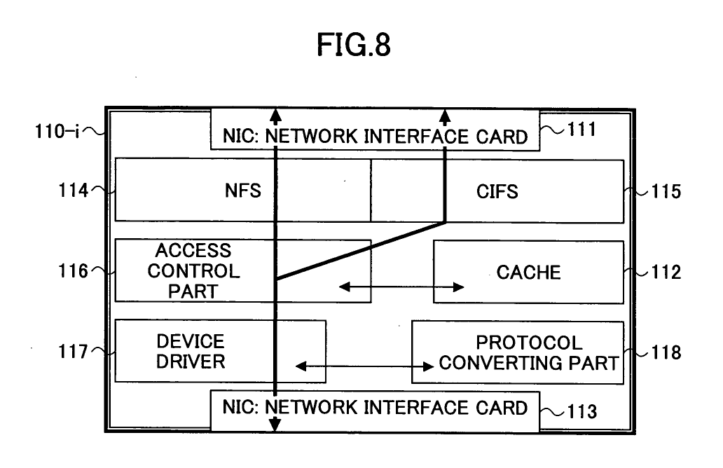

As shown in FIG. 8, the request processing server 110 includes a network connection device (NIC: LAN card) 113 used for connecting with the volume management server 120, and a network connection device (NIC: LAN card) 111 used for connecting with the business server 10 (or via the load sharing server 30). The request processing server 110 accepts a processing request in an access protocol (NFS or CIFS protocol) from the business server 10 via the network 20, and analyses it with protocol analysis parts 114 and 115.

In the request processing server 110, logical (virtual) volumes which are generated by the volume management server 120 for the disks 50 are made accessible as mentioned above, and, when the request processing server 110 accesses the logical (virtual) volume generated by the volume management server 120, the access is made via the network (LAN) 130. As a protocol used in issuance of the access request to the volume management server 120 by the request processing server 110, IP/SAN (iSCSI (Internet SCSI)) or so may be preferably applied (‘IP/SAN’ is an abbreviation of ‘IP Storage Area Network’; and ‘iSCSI’ is an abbreviation of ‘Internet SCSI’). The request processing server 110 has a function of converting the processing request in the network access protocol issued by the business server 10 into an instruction in a protocol usable for accessing the logical (virtual) volumes of the disks 50 generated by the volume management server 120.

The request processing server 110 has a cache 112 as shown in FIGS. 7 and 8, and, has a function of, when receiving an access request in an established transaction, reading a file data from the cache 112 and transferring it to the business server 10 without actually issuing an access request to the volume management server 120 when it is available in the cache.

The communication network (LAN) connecting between the request processing servers 110 and the volume management server 120 is preferably a private network (local LAN) as mentioned above. However, it is also possible that this network may be shared by another external system. Further, in the configuration shown in FIGS. 6 and 7, the network file server 100 is connected with the respective business servers 10 via the load sharing server 30. However, it is not necessary to be limited to this configuration. That is, a form of accepting a network access protocol from the business servers may be one in which, as described above, the load sharing server 30 accepts all the requests given first collectively. However, the load sharing server 30 may be omitted, and in this case, each business server 10 may issue an access request directly to a particular one of the request processing servers 110.

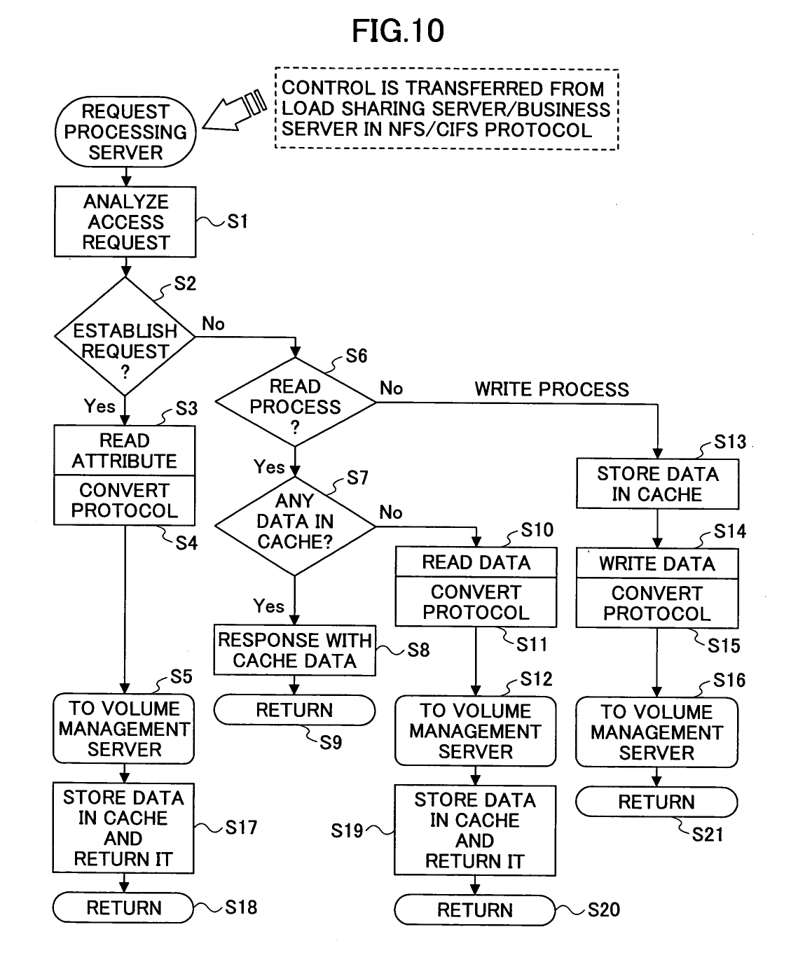

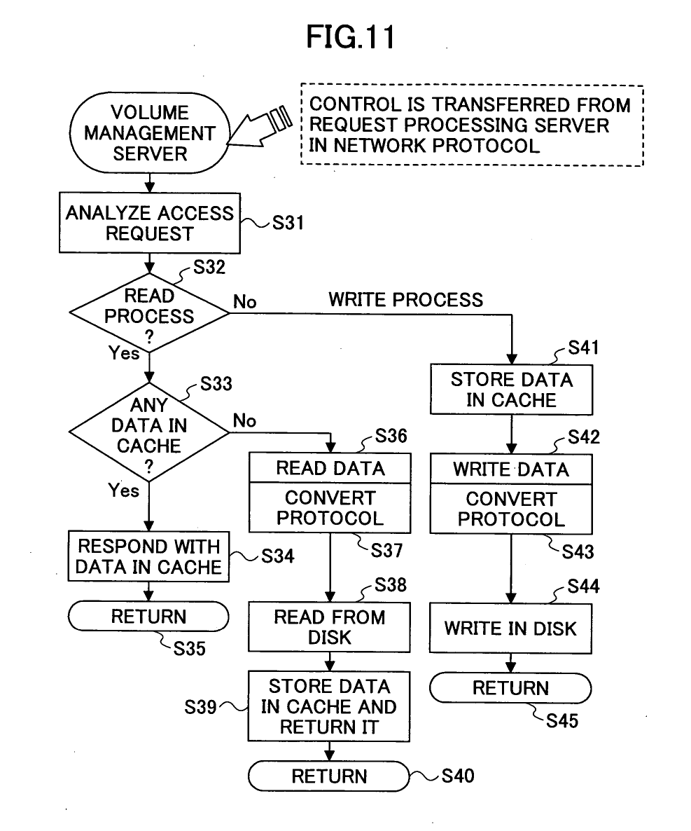

With reference to FIGS. 10 and 11, processing operation performed in the network file server 100 will now be described in detail. The request processing server 110 accepts an access request for a file stored in the disk 50 in a predetermined network access protocol from the business server 10 or the load sharing server 30 with the above-mentioned NIC 111. This access request is made to undergo predetermined processing performed thereto by the protocol processing parts 114 and 115 according to the received type of the communication protocol, and then, is analyzed by the access control part 116 in Step S1 in FIG. 10. When it is determined that this request is a file creation request (Yes in Step S2), the access control part 116 in the request processing server 110 issues an access request for obtaining meta-data information for a target file (attribute information or so for a file), and transmits this request to the protocol converting part 118 via the device driver 117 in Steps S3. The access request in a protocol of IP/SAN (iSCSI) thus obtained through the protocol conversion in Step S4 is issued for the volume management server 120 via the NIC 113 in Step S5.

The volume management server 120 accepts this access request with the NIC 121, and analyses it with the disk access control part 124 in Step S31 in FIG. 11. Then, according to a result of the analysis, in order to obtain the relevant meta-data information, disk access is performed onto the storage 50 with a predetermined disk access protocol (Yes in Step S32). In this case, it is determined whether or not the relevant latest data occurs in the own cache 122 in Step S33, and, when it occurs in the cache 122 (Yes), no actual access is made to the disk 50, but a response for the request processing server 110 is made with the meta-data information obtained from the cache 122 in Steps S34 and S35. The request processing server 110 receiving this response stores the received data in the own cache, and also, a response is made for the business server therewith, in Steps S17 and S18.

However, when the relevant latest data does not occur in the cache 122 (No in Step S33), the volume management server 120 issues an access request for obtaining the relevant meta-data information from the disk 50, which is then processed in the protocol converting part 125, in Steps S36 and S37. The access request in a protocol of SCSI, fibre channel or so thus obtained through the protocol conversion is then transmitted to the device driver 126, and therethrough, the disk request thus converted is transmitted to the disk 50 via the HBA 123.

As a result, the relevant meta data is read out from the disk 50 in Step S38, this data is then stored in the cache 122 of the volume management server 120, and also, is transmitted to the request processing server 110 as a response, in Steps S39 and S40. The request processing server 110 receiving this meta data stores it in the own cache 112 and also transmits it to the business server 10 as a response in Steps S17 and S18.

When a request given by the business server 10 is a reading or writing request (No in Step S2), the request processing server 110 issues an access request in a protocol of IP/SAN (iSCSI) or so for reading out or write in target data from/to the disk 50, to the volume management server 120. Then, when the above-mentioned request from the business server 10 is a reading request (Yes in Step S6), it is determined whether or not the relevant latest file data as target data occurs in the cache 112 in Step S7. When it occurs there (Yes), the request processing server 110 does not actually issue the access request to the volume management server 120 but transmits the relevant data obtained from the cache 112 to the business server 10 as a response in Steps S8 and S9.

When the relevant file data does not occur in the cache 112 (No in Step S7), the request processing server 110 actually issues the access request for obtaining the relevant file data, and performs protocol conversion thereon in Steps S10 and S11. Then, for the volume management server 120, the access request in a protocol of IP/SAN (iSCSI) or so thus converted is issued, in Step S12.

When the above-mentioned access request given by the business server 10 is a writing request (No in Step S6), the relevant data is first written in the cache 112 in Step S13, and after that, an access request for dispatching the data thus written in the cache 112 also to the volume management server 120 is issued and protocol conversion is performed thereon in Steps S14 and S15. Then, for the volume management server 120, the access request in a protocol of IP/SAN (iSCSI) or so thus converted is issued, in Steps S16 and S21.

When accepting the above-mentioned access request for reading the relevant file data issued by the request processing server 110 in Step S12, the volume management server 120 analyzes it in Step S31. As a result, as this request is a request for reading the file data (Yes in Step S32), disk access for obtaining the relevant file data is performed in a disk access protocol. However, when the relevant latest file data occurs in the cache 122 (Yes in Step S33), no actual access to the disk 50 is performed, but the file data is read out from the cache 122, and the thus-obtained data is transmitted to the request processing server as a response, in Steps S34 and S35. The request processing server 110 receiving this file data as a response stores it in the own cache 112, and also, transmits the same as a response to the relevant business server 10, in Steps S19 and S20.

When the relevant file data does not occur in the cache 122 (No in Step S33), an access request for reading out the relevant file data from the disk 50 is issued, protocol conversion is performed on the access request, and the thus-protocol-converted access request is issued, in Steps S36 and S37.

After thus accessing the disk 50 and reading out therefrom relevant file data in Step S38, the volume management server 120 stores this data in the own cache 122 and also transmits the same to the request processing server 110 as a response in Steps S39 and S40. The request processing server 110 receiving this file data as a response stores it in the own cache and also transmits the same to the relevant business server 10 as a response in Steps S19 and S20.

When the volume management server 120 receives the above-mentioned data writing request from the request processing server 110 in Step S16, the volume management server 120 analyzes it in Step S31. As this request is a request for writing the file data in this case (No in Step S32), the relevant data is once written in the own cache 122 in Step S41. After that, an access request for writing the relevant data in the disk 50 is issued, and is protocol-converted into the disk access protocol in Steps S42 and S43. Then, the thus-protocol-converted access request in the disk access protocol is used for performing actual disk access to the disk 50 so that the relevant file data is written in a predetermined area of the disk 50 in Steps S44 and S45.

Each of the above-mentioned request processing server 110 and the volume management server 120 may be configured by a computer, and, in this case, a CPU of the computer reads a software program prepared for causing the computer to execute the operation described with reference to FIG. 10 or 11, and acts as the request processing server 110 or the volume management server 120 by executing respective instructions of the relevant software program. Each of these software programs may be provided to the computer via a computer readable information recording medium such as a CD-ROM or so in which the software program is previously written.

The present invention is not limited to the above-described embodiment, and variations and modifications may be made without departing from the claimed scope of the present invention.

For example, the present invention can be embodied by modifying a conventional well-known network file server, i.e., a NAS server or an NFS server, such as that disclosed by United States patent publication, US2002/0065916 A1, publicized on May 30, 2002, for example, in a manner such that a communication network such as a LAN is inserted in the network file server between a part which accepts an access request coming from a client and a part which actually accesses a file system (storage) in response to the access request. Thus, any configuration obtained from modifying a conventional network file server in such a manner is regarded as an embodiment of the present invention.

The present application is based on Japanese priority application No. 2003-177656, filed on Jun. 23, 2003, the entire contents of which are hereby incorporated by reference.

What is claimed is:

1. A network file server comprising:
a data storage device;
a request processing part connected to each server on a user's side via a predetermined backbone communication network, receiving a request from the server on the user's side for data processing including access to said data storage device, and issuing an instruction to a storage device management part for analyzing and responding to said request; and
the data storage device management part connected with said request processing part via a predetermined local communication network, and executing predetermined processing including access to said data storage device based on the instruction issued by said request processing part.

2. The network file server as claimed in claim 1, wherein:
said request processing part has a function of converting the request for data processing including access to the storage device issued by the server on the user's side into an instruction corresponding to a logical configuration in said data storage device; and
said storage device management part has a function of converting the instruction corresponding to the logical configuration in the data storage device received from said request processing part into an instruction corresponding to a physical configuration in the data storage device.

3. The network file server as claimed in claim 1, wherein:
said storage device management part has a cache, and, when data requested by said request processing part occurs in said cache, reads the data from said cache without actually accessing the data storage device, and transfers the read data to said request processing part.

4. The network file server as claimed in claim 1, wherein:
said request processing part has a cache, and, when data requested by the server on the user's side occurs in said cache, reads the data from said cache without transferring the processing request to the storage device management part, and transfers the read data to said server on the user's side.

5. An information processing apparatus connected to each server on a user's side via a predetermined backbone communication network, receiving a request from the server on the user's side for data processing including access to a predetermined data storage device, and issuing an instruction to a storage device management part for analyzing and responding to said request.

6. The information processing apparatus as claimed in claim 5, having a function of converting the request for data processing including access to the storage device issued by the server on the user's side into an instruction corresponding to a logical configuration in said data storage device.

7. The information processing apparatus as claimed in claim 5, having a cache, and, when data requested by the server on the user's side occurs in said cache, reading the data from said cache without transferring the processing request to the storage device management part, and transferring the read data to said server on the user's side as a response.

8. An information processing apparatus, connected with a predetermined request processing part via a predetermined local communication network, and executing predetermined processing including access to a predetermined data storage device based on an instruction issued by the predetermined request processing part.

9. The information processing apparatus as claimed in claim 8, having a cache, and, when data requested by the predetermined request processing part occurs in said cache, reading the data from said cache without actually accessing the predetermined data storage device, and transferring the read data to said request processing part as a response.

10. The information processing apparatus as claimed in claim 8, having a function of converting an instruction corresponding to a predetermined logical configuration in the predetermined data storage device received from the predetermined request processing part into an instruction corresponding to a physical configuration in said data storage device.

11. A computer readable program causing a computer to execute the steps of:
a) receiving from a server in a user's side a request for data processing including access to a predetermined data storage device; and
b) issuing an instruction for a predetermined storage device management part connected via a predetermined local communication network for analyzing and responding to said request.

12. The computer readable program as claimed in claim 11, further causing the computer to execute the step of:
c) converting the request for data processing including access to the data storage device from the server on the user's side into an instruction corresponding to a logical configuration in said data storage device.

13. The computer readable program as claimed in claim 11, further causing the computer to execute the step of:
c) responding to a request issued by the server on the user's side for taget data without transferring said request to the storage device management part when the target data occurs in a cache of its own, by reading the target data from the cache and transferring it to said server on the user's side as a response.

14. A computer readable program causing a computer to execute the step of:
a) executing predetermined data processing including access to a predetermined data storage device based on an instruction issued by a request processing device connected via a predetermined local communication network.

15. The computer readable program as claimed in claim 14, further causing the computer to execute the step of:
b) responding to a request from the request processing device for data without actually accessing the predetermined data storage device when the requested data occurs in a cache of its own, by reading the relevant data from the cache and transferring it to said request processing device as a response.

16. The computer readable program as claimed in claim 14, further causing the computer to execute the step of:
b) converting an instruction received from the request processing device corresponding to a predetermined logical configuration in the data storage device into an instruction corresponding to a physical configuration in said data storage device.

17. A computer readable information recording medium storing therein the computer readable program claimed in claim 11.

18. A computer readable information recording medium storing therein the computer readable program claimed in claim 12.

19. A computer readable information recording medium storing therein the computer readable program claimed in claim 13.

20. A computer readable information recording medium storing therein the computer readable program claimed in claim 14.

21. A computer readable information recording medium storing therein the computer readable program claimed in claim 15.

22. A computer readable information recording medium storing therein the computer readable program claimed in claim 16.
